(19) United States
(12) Patent Application Publication
(10) Pub. No.: US 2026/0180415 A1
(43) Pub. Date: Jun. 25, 2026

(54) SUPERCONDUCTING MOTOR COMPRISING COILS INSULATED BY TWO VACUUM LAYERS

(71) Applicant: AIRBUS SAS, Blagnac (FR)

(72) Inventors: Alexandre COLLE, Blagnac (FR); François DUNOYER, Blagnac (FR)

(73) Assignee: AIRBUS SAS, Blagnac (FR)

(21) Appl. No.: 19/427,763

(22) Filed: Dec. 19, 2025

(30) Foreign Application Priority Data
Dec. 19, 2024 (FR) 2414572

(51) Int. Cl. H02K 55/00; H02K 1/27; H02K 5/10

(52) U.S. Cl. CPC H02K 55/00; H02K 1/27; H02K 5/10

(57) ABSTRACT

A superconducting motor that includes a rotor, a stator and a motor casing. The motor casing has a common chamber which has been evacuated and includes multiple sealed compartments which have also been evacuated, each sealed compartment enclosing one or more coils of the stator, such that the coil(s) in each sealed compartment is/are thermally insulated by two vacuum layers, a first vacuum layer in the sealed compartment in question and a second vacuum layer in the common chamber. Thus, any particles that could become detached from a failed coil do not damage the thermally insulating barrier of any other coil which would be accommodated in another compartment.

### TECHNICAL FIELD

The present invention relates to the general field of superconducting motors.

### PRIOR ART

As schematically illustrated in FIGS. 1 and 2, a superconducting motor of the prior art comprises a rotor 102 which has a rotor core made of a ferromagnetic material such as the collection of iron alloys used for electric machines. The rotor core is cylindrical overall and it has a central bore into which a drive shaft 101 is fitted and rigidly fixed. The drive shaft 101 is coaxial with the axis of revolution of the rotor core, superposed with the longitudinal axis X of the superconducting motor.

The rotor 102 also comprises permanent magnets borne by the rotor core. There are several permanent magnets distributed angularly and evenly around the periphery of the rotor core and spaced apart from one another. For the sake of simplicity, the permanent magnets are not shown in detail in FIGS. 1 and 2 and are represented by an assembly 112.

The superconducting motor comprises a stator 103 which is positioned outside the rotor 102 and which has a stator core made of a ferromagnetic material such as the collection of iron alloys used for electric machines. The stator core has a hollow-cylindrical overall shape coaxial with the longitudinal axis X.

The stator 103 comprises a set of multiple coils 113 borne by the stator core, distributed angularly and evenly around the internal periphery of the stator core (such that they face the set of permanent magnets 112) and spaced apart from one another. Each coil 113 consists of a strip of superconducting material. In particular, the strip of superconducting material is wound radially to the longitudinal axis X so as to form one said coil 113.

The rotor 102 and the stator 103 are accommodated in a cylindrical motor casing 120 closed at its two ends by endplates 121, 122, at least one of which is pierced with a central orifice allowing the passage of the drive shaft 101. The stator 103 is mounted fixedly inside the motor casing 120 while the assembly formed by the rotor 102 and the drive shaft 101 is mounted with the freedom to rotate inside the motor casing 120.

In operation, each coil 113 is supplied with electrical power in order to generate a magnetic field which interacts with the permanent magnets, thus driving the rotor 102 and the drive shaft 101 in rotation. An electrical power supply circuit and electronic circuitry for controlling the electrical power supply intended to supply each coil 113 with electrical power are installed in one or more control boxes 130, for example attached to the motor casing 120. For the sake of simplicity, the electrical connection connecting the electrical power supply and each coil 113 is not illustrated in FIGS. 1 and 2.

The motor casing 120 has an inner wall 124 and an outer wall 123. For example, the inner wall 124 and the outer wall 123 are in the form of cylinders which are coaxial with the longitudinal axis X. The inner wall 124 is positioned between the rotor 102 and the stator 103, and the outer wall 123 is positioned around the stator 103 (on the side farthest from the longitudinal axis X). The inner wall 124 and the outer wall 123 extend between the two endplates 121, 122 to which said walls are attached in sealed fashion such that the walls 123, 124 together with the two endplates 121, 122 delimit a chamber 125 which is inside the motor housing 120 and contains the stator 103 and the coils 113 which it bears. This chamber 125 is evacuated and acts as thermal insulation for the coils 113 of the stator 103.

If a coil 113 were to fail, particles of the coil could become detached, thereby running the risk of adversely affecting the thermal insulation performance of the chamber 125. This could degrade the performance of the superconducting motor.

It is therefore desirable to provide a solution that makes it possible to improve the performance of the superconducting motor if a coil fails.

### SUMMARY OF THE INVENTION

To this end, what is proposed here is a superconducting motor comprising: a rotor bearing permanent magnets which are able to rotate about a longitudinal axis; a stator bearing coils that are to be supplied with electrical power in order to generate a magnetic field which drives the rotor in rotation by virtue of the permanent magnets; and a motor casing. The superconducting motor is such that the motor casing has a common chamber which has been evacuated and includes multiple sealed compartments which have also been evacuated, each sealed compartment enclosing one or more coils of the stator, such that the coil(s) in each sealed compartment are thermally insulated by two vacuum layers, a first vacuum layer in the sealed compartment in question and a second vacuum layer in the common chamber.

Thus, by separating the coils into sealed compartments, any particles that could become detached from a failed coil would not damage the thermally insulating barrier of any other coil which would be accommodated in a sealed compartment other than the one in which the failed coil is accommodated or the thermally insulating barrier created by the evacuation of the common chamber. This improves the performance of the superconducting motor if a coil fails.

In one particular embodiment, the superconducting motor is further arranged such that each coil is insulated from at least half of the coils of the stator by virtue of the sealed compartments.

In one particular embodiment, each coil is accommodated in a dedicated sealed compartment of said sealed compartments.

In one particular embodiment, the sealed compartments are made of an electrically insulating material.

In a particular embodiment, each sealed compartment has a parallelepipedal overall shape and comprises a receptacle portion and a cover portion, and, for each coil, the receptacle has internal walls forming a well in which a stator core element made of ferromagnetic material is accommodated right in the middle of the turns of the coil in question but outside the sealed compartment.

In one particular embodiment, for each coil, the receptacle has two retaining ribs, one on each side of the well, designed to hold the coil in place in the sealed compartment.

In one particular embodiment, in each sealed compartment, each coil is associated with a cryogenic element.

In one particular embodiment, the cryogenic element is a duct along the associated coil, through which a heat-transfer fluid flows.

Also proposed is an aircraft comprising at least one superconducting motor in any one of the embodiments presented above.

### BRIEF DESCRIPTION OF THE DRAWINGS

The abovementioned features of the invention, along with others, will become more clearly apparent upon reading the following description of at least one exemplary embodiment, said description being provided with reference to the appended drawings, in which:

FIG. 1 shows a simplified view in cross section of a superconducting motor according to the prior art;

FIG. 2 shows a simplified top view of the superconducting motor arrangement in FIG. 1;

FIG. 3 shows a simplified view in cross section showing the principle of a thermal barrier with two vacuum layers;

FIG. 4 shows a perspective view of a portion of a sealed compartment which makes it possible to provide one of said vacuum layers;

FIG. 5 shows a simplified view in cross section of a sealed compartment;

FIG. 6 shows a perspective view of a portion of a sealed compartment which makes it possible to provide one of said vacuum layers, according to another arrangement;

FIG. 7 shows a partial perspective view of one particular arrangement of couplings for a coil and for a cryogenic element that are accommodated in one said sealed compartment; and

FIG. 8 shows a perspective view of an aircraft comprising at least one superconducting motor which has coils to which the principle of a thermal barrier with two vacuum layers has been applied.

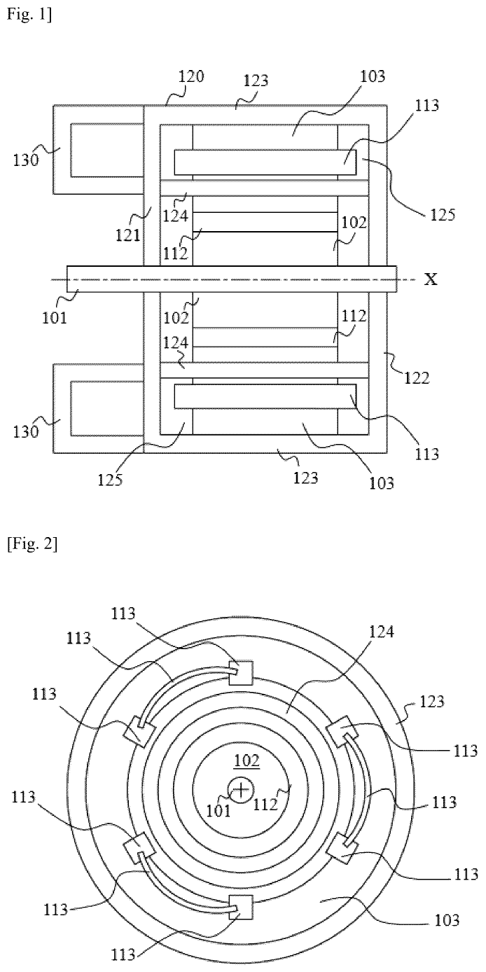

### DETAILED DESCRIPTION OF EMBODIMENTS

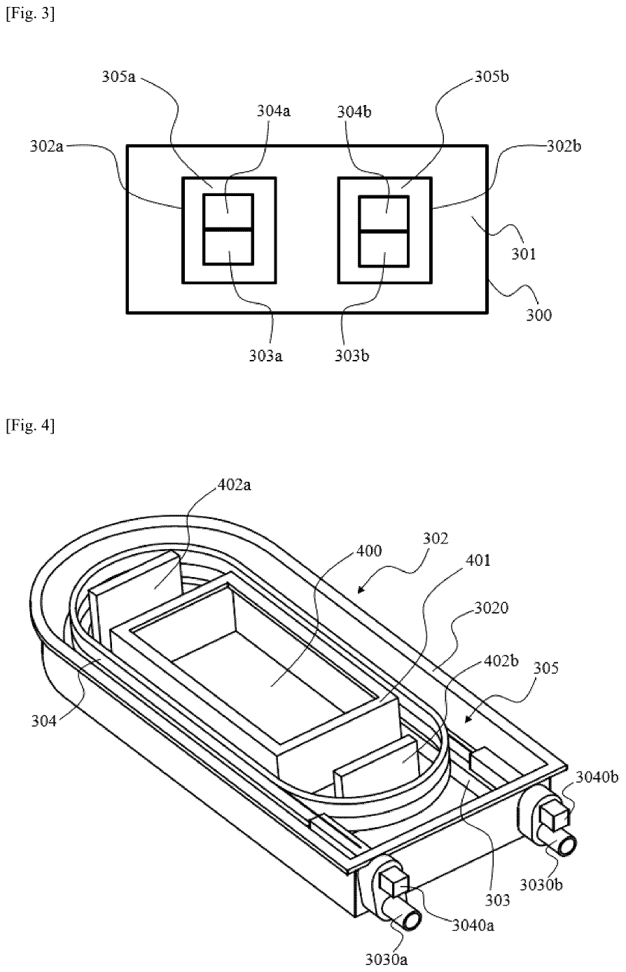

FIG. 3 shows a simplified view in cross section showing the principle of a thermal barrier with two vacuum layers.

FIG. 3 schematically shows a common chamber 300 of the motor casing. The common chamber 300 has been evacuated.

The common chamber 300 includes multiple sealed compartments 302a, 302b which have also been evacuated.

Each sealed compartment 302a, 302b encloses one or more coils 304a, 304b of the stator, the coils 304a, 304b being made of superconducting material.

The superconducting motor is such that the coil(s) 304a, 304b in each sealed compartment 302a, 302b is/are thermally insulated by two vacuum layers: a first vacuum layer 305a, 305b in the sealed compartment 302a, 302b in question, and a second vacuum layer 301 in the common chamber 300. The first vacuum layer 305a, 305b makes it possible to partially provide the thermally insulating barrier useful for the operation of the coils 304a, 304b and more generally for the superconducting motor, and makes it possible to ensure that any particles which would become detached from a coil 304a, 304b that fails would not damage the thermally insulating barrier of any other coil 304a, 304b which would be accommodated in a sealed compartment 302a, 302b other than the one in which the failed coil is accommodated. This improves the performance of the superconducting motor if a coil 304a, 304b fails. The second vacuum layer 301, in the common chamber 300, makes it possible to provide, in addition to the first vacuum layer 305a, 305b afforded by the sealed compartments 302a, 302b, a complete thermally insulating barrier for all of the coils 304a, 304b of the stator.

It should be noted that each sealed compartment 302a, 302b can contain one or more coils 304a, 304b of the stator. One particular embodiment of a sealed compartment 302a, 302b intended to contain just a single coil 304a, 304b is presented below with reference to FIG. 4. A variant intended to contain two coils is presented below with reference to FIG. 6.

In one particular embodiment, the superconducting motor is further arranged such that each coil 304a, 304b is insulated from at least half of the coils of the stator by virtue of the sealed compartments 302a, 302b. Thus, the superconducting motor retains some of its performance if a coil of the stator fails.

In one particular embodiment, each coil 304a, 304b has a dedicated sealed compartment 302a, 302b, thus insulating it from all the other coils of the stator 103. Thus, if a coil 304a, 304b is damaged, it will not have an impact on the thermally insulating barrier of each of the other coils of the stator 103.

In one particular embodiment, the sealed compartments 302a, 302b are made of an electrically insulating material.

In one particular embodiment, each coil 304a, 304b is associated with a cryogenic element 303a, 303b for exchanging heat. For example, these cryogenic elements 303a, 303b comprise ducts which are respectively positioned along the coils 304a, 304b and through which flows a heat-transfer fluid coming from a reservoir (not shown) of heat-transfer fluid and driven by any suitable system such as a pump. The heat-transfer fluid is, for example, helium gas. Thus, in each sealed compartment 302a, 302b, the thermally insulating barrier is formed by a vacuum layer surrounding each coil 304a, 304b and each cryogenic element located therein.

FIG. 4 shows a perspective view of a portion of a sealed compartment (referenced 302 in FIG. 4) which makes it possible to provide said first vacuum layer (referenced 305 in FIG. 4).

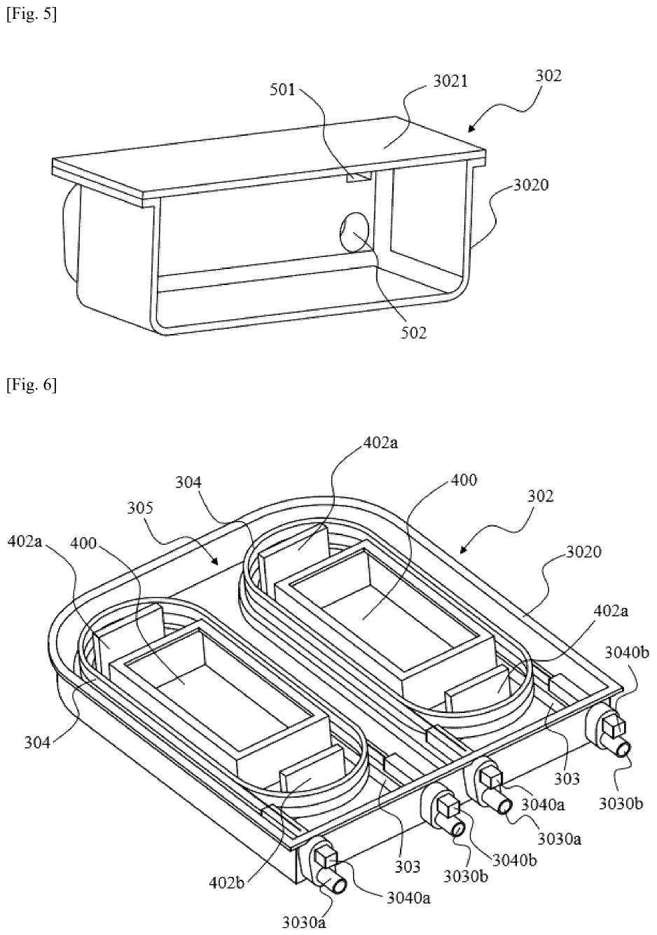

The sealed compartment 302 in FIG. 4 comprises a receptacle 3020 in which the coil (referenced 304 in FIG. 4) is accommodated and which is provided with a cover 3021 (not shown in FIG. 4, but shown in FIG. 5).

The coil 304 is formed for example by a strip made of superconducting material wound on itself to form turns which are flat overall. In a variant, the coil 304 may be formed by multiple parallel strips made of superconducting material, placed side by side and wound on themselves to form turns which are flat overall. The receptacle 3020 shown in FIG. 4 has, on its bottom surface (wall facing an opening intended to receive the cover 3021), two retaining ribs 402a, 402b, which are designed to hold the coil 304 in place in the sealed compartment 302.

In FIG. 4, the receptacle 3020 has internal walls 401 forming a well 400, for example of rectangular shape, in which a stator core element made of ferromagnetic material is intended to be accommodated right in the middle of the turns of the coil 304 but outside the sealed compartment 302. Preferably, as illustrated in FIG. 4, the retaining ribs 402a, 402b are located one on each side of the well 400.

The receptacle 3020 has a connection wall by way of which the coil 304 is electrically connected. The coil 304 thus has two connection ends 3040a, 3040b which pass through dedicated respective orifices 501 (see FIG. 5) in the connection wall. In FIG. 4, the connection wall is a side wall with respect to the bottom of the receptacle 3020.

As illustrated in FIG. 4, the receptacle 3020 is preferably designed to also accommodate a cryogenic element intended for cooling the coil 304. For example, a duct 303 is placed side by side with the coil 304 in the receptacle 3020, the duct 303 then following all or some of the flat overall shape of the turns of the coil 304. Better cryogenic efficiency and better management of the space are obtained by having the cryogenic duct, in the sealed compartment, run along the coil and “all around the well”. The duct 303 then has two connection ends 3030a, 3030b which pass through dedicated respective orifices 502 (see FIG. 5) in the connection wall.

The orifices 501, 502 mentioned above appear in FIG. 5, which depicts a simplified view in section of the sealed compartment 302 which also depicts the cover 3021. The join between the receptacle 3020 and the cover 3021 is such that the airtightness of the compartment 302 is ensured. For example, the cover 3021 is sealed to the receptacle 3020 by an adhesive or by welding (e.g. plastic welding). In addition, the join between the connection wall and the connection ends 3040a, 3040b, 3030a, 3030b is such that the airtightness of the compartment 302 is ensured, for example by a layer of adhesive.

The sealed compartment 302 in FIG. 4 has a parallelepipedal overall shape with a rounded side in the direction away from the connection wall so as to substantially follow the rounded shape of the turns of the coil 304.

As already indicated, the sealed compartment 302 may include multiple coils 304. An arrangement with two coils which are coplanar (side by side) is illustrated in a perspective view in FIG. 6. Thus, on its bottom surface (wall facing an opening intended to receive the cover 3021), the receptacle 3020 has two sets of two retaining ribs 402a, 402b, each of these sets of two ribs being designed to hold one said coil 304 in place in the sealed compartment 302. In addition, the connection wall has two sets of orifices 501, 502 as described above, so as to allow the passage of the connection ends 3040a, 3040b, 3030a, 3030b of the two coils 304.

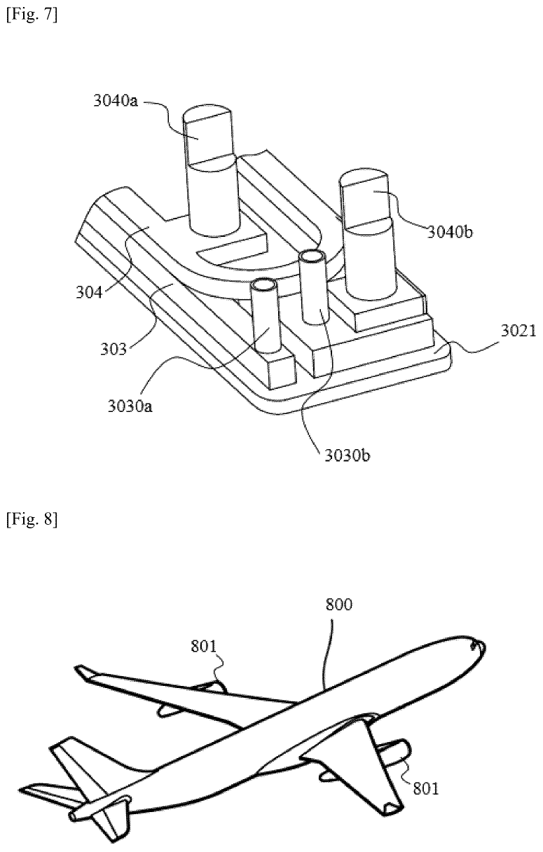

In a variant embodiment, one particular arrangement of the connection ends 3040a, 3040b, 3030a, 3030b, as schematically illustrated in a partial perspective view in FIG. 7, allows the sealed compartment 302 to be made more compact. The connection ends 3040a, 3040b are then perpendicular to the plane(s) of the turns of the coil 304. Similarly, the connection ends 3030a, 3030b are then perpendicular to the plane of the duct 303. The connection wall then, as imparted in the diagram of FIG. 7, coincides with the bottom of the receptacle 3020. In an equivalent variant, the connection wall then coincides with the cover 3021.

FIG. 8 shows a perspective view of an aircraft 800.

The aircraft 800 comprises at least one superconducting motor which has coils to which the principle of a thermal barrier with two vacuum layers, according to any one of the embodiments presented above, has been applied. For example, the aircraft 800 uses such a superconducting motor in each propulsion engine 801, typically to drive a propeller in rotation.

1. A superconducting motor comprising:
a rotor bearing permanent magnets which are able to rotate about a longitudinal axis,
a stator bearing coils intended to be supplied with electrical power in order to generate a magnetic field that drives the rotor in rotation by virtue of the permanent magnets,
a motor casing,
wherein:
the motor casing has a common chamber which has been evacuated and includes multiple sealed compartments which have also been evacuated, each sealed compartment enclosing one or more coils of the stator, such that the coil(s) in each sealed compartment are thermally insulated by two vacuum layers, a first vacuum layer in the sealed compartment in question and a second vacuum layer in the common chamber,
each sealed compartment has a parallelepipedal overall shape and comprises a receptacle portion and a cover portion, and, for each coil, the receptacle has internal walls forming a well in which a stator core element made of ferromagnetic material is accommodated right in the middle of the turns of the coil (304, 304a, 304b) in question but outside the sealed compartment,
and in each sealed compartment, each coil is associated with a cryogenic element in the form of a duct which runs along the coil and all around the well and through which a heat-transfer fluid flows.

2. The superconducting motor according to claim 1, wherein each sealed compartment has a connection wall with dedicated respective orifices for the ends of the coil and dedicated respective orifices for the ends of said duct in said sealed compartment.

3. The superconducting motor according to claim 1, further arranged such that each coil is insulated from at least half of the coils of the stator by virtue of the sealed compartments.

4. The superconducting motor according to claim 1, wherein each coil is accommodated in a dedicated sealed compartment of said sealed compartments.

5. The superconducting motor according to claim 1, wherein the sealed compartments are made of an electrically insulating material.

6. The superconducting motor according to claim 1, wherein, for each coil, the receptacle has two retaining ribs, one on each side of the well, designed to hold the coil in place in the sealed compartment.

7. An aircraft comprising at least one superconducting motor according to claim 1.
